(19) United States
(12) Patent Application Publication
(10) Pub. No.: US 2026/0291938 A1
(43) Pub. Date: Sep. 24, 2026

(54) SECURE COMMUNICATION METHOD AND APPARATUS

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/874,315

(22) PCT Filed: Jun. 20, 2022
(86) PCT No.: PCT/CN2022/099964

§ 371 Date: Dec. 12, 2024

(51) Int. Cl. H04L 9/40

(52) U.S. Cl. CPC H04L 63/10; H04L 63/061; H04L 63/0876

(57) ABSTRACT

Provided are a secure communication method and apparatus. The secure communication method is applied to an authentication and key management for applications (AKMA) authentication proxy and includes: receiving a service request of a target application server sent by a user equipment (UE), wherein the service request carries identification information of the target application server and an AKMA key identifier (A-KID) of the UE; performing authentication and authorization on the UE according to the A-KID and the identification information of the target application server, and determining whether to authorize the UE to access the target application server; and in response to authorizing the UE to access the target application server, forwarding the service request and an authentication result of the UE to the target application server.

### CROSS-REFERENCE TO RELATED APPLICATION

The application is a U.S. National Stage of International Application No. PCT/CN 2022/099964 filed on Jun. 20, 2022, the entire content of which is incorporated herein by reference.

### TECHNICAL FIELD

The present application relates to the technical field of communication, and in particular, to a secure communication method and apparatus.

### BACKGROUND

In the 5G network environment, the initial shared session key can be provided for the User Equipment (UE) and the Application Function (AF) network element of the application through the Authentication and Key Agreement (AKA) technology between the mobile terminal and the mobile network, thereby ensuring the secure communication between the UE and the AF network element. This technology is called Authentication and Key management for Applications based on the 3rd generation partnership project (3GPP) credentials (AKMA).

### SUMMARY

The present application proposes a secure communication method and apparatus.

The embodiment in the first aspect of the present application provides a secure communication method. The method is applied to an AKMA authentication proxy. The method includes: receiving a service request of a target application server (target AS) sent by a user equipment (UE), where the service request carries identification information of the target application server and an AKMA key identifier (A-KID) of the UE; performing authentication and authorization on the UE according to the A-KID and the identification information of the target application server, and determining whether to authorize the UE to access the target application server; and in response to authorizing the UE to access the target application server, forwarding the service request and an authentication result of the UE to the target application server.

The embodiment in the second aspect of the present application provides a secure communication method, which is applied to a user equipment (UE). The method includes: sending a service request of a target application server to an AKMA authentication proxy, where the service request carries identification information of the target application server and an AKMA key identifier (A-KID) of the UE; and receiving response information returned by the AKMA authentication proxy.

The embodiment in the third aspect of the present application provides a secure communication method, which is applied to a target application server. The method includes: receiving a service request from a user equipment (UE) and an authentication result of the UE sent by an AKMA authentication proxy; where the service request carries identification information of the target application server and an AKMA key identifier (A-KID) of the UE; and sending a service response of the service request to the UE through the AKMA authentication proxy according to the authentication result of the UE.

The fourth aspect of the present application provides a secure communication apparatus, applied to an authentication and key management for applications (AKMA) authentication proxy, including: a receiving module, configured to receive a service request of a target application server sent by a user equipment (UE), where the service request carries identification information of the target application server and an AKMA key identifier (A-KID) of the UE; an authentication module, configured to perform authentication and authorization on the UE according to the A-KID and the identification information of the target application server, and determine whether to authorize the UE to access the target application server; and a sending module, configured to, in response to authorizing the UE to access the target application server, forward the service request and an authentication result of the UE to the target application server.

The embodiment in the fifth aspect of the present application provides a secure communication apparatus, applied to a user equipment (UE), including: a sending module, configured to send a service request of a target application server to an authentication and key management for applications (AKMA) authentication proxy, where the service request carries identification information of the target application server and an AKMA key identifier (A-KID) of the UE; and a receiving module, configured to receive response information returned by the AKMA authentication proxy.

The embodiment in the sixth aspect of the present application provides a secure communication apparatus, applied to a target application server, including: a receiving module, configured to receive a service request from a user equipment (UE) and an authentication result of the UE sent by an authentication and key management for applications (AKMA) authentication proxy, where the service request carries identification information of the target application server and an AKMA key identifier (A-KID) of the UE; and a sending module, configured to send a service response of the service request to the UE through the AKMA authentication proxy according to the authentication result of the UE.

The embodiment in the seventh aspect of the present application provides a secure communication system, including: an authentication and key management for applications (AKMA) authentication proxy, a user equipment (UE), and a target application server, where the AKMA authentication proxy receives a service request of the target application server sent by the UE, where the service request carries identification information of the target application server and an AKMA key identifier (A-KID) of the UE; the AKMA authentication proxy performs authentication and authorization on the UE according to the A-KID and the identification information of the target application server, determines whether to authorize the UE to access the target application server, and in response to authorizing the UE to access the target application server, forwards the service request and an authentication result of the UE to the target application server; the target application server sends a service response of the service request to the UE through the AKMA authentication proxy according to the authentication result of the UE.

The embodiment in the eighth aspect of the present application provides a communication device. The communication device includes: a transceiver; a memory; and a processor, respectively connected to the transceiver and the memory, and configured to, by executing computer-executable instructions on the memory, control the transceiver to receive and send a wireless signal, and can implement the method as in the embodiment in the first aspect or the embodiment in the second aspect or the embodiment in the third aspect of the present application.

The ninth embodiment of the present application provides a computer storage medium, where the computer storage medium stores computer-executable instructions; and after the computer-executable instructions are executed by a processor, the method as in the embodiment in the first aspect or the embodiment in the second aspect or the embodiment in the third aspect of the present application can be implemented.

Additional aspects and advantages of the present application will be set forth in part in the following description, and will in part be obvious from the following description, or may be learned by practice of the present application.

### BRIEF DESCRIPTION OF THE DRAWINGS

The above and/or additional aspects and advantages of the present application will become apparent and readily understood from the following description of the embodiments in conjunction with the accompanying drawings, in which:

FIG. 1 is a schematic flowchart of a secure communication method according to an embodiment of the present application;

FIG. 2 is a schematic flowchart of a secure communication method according to an embodiment of the present application;

FIG. 3 is a schematic flowchart of a secure communication method according to an embodiment of the present application;

FIG. 4 is a schematic flowchart of a secure communication method according to an embodiment of the present application;

FIG. 5 is a schematic flowchart of a secure communication method according to an embodiment of the present application;

FIG. 6 is a schematic flowchart of a secure communication method according to an embodiment of the present application;

FIG. 7 is a schematic flowchart of a secure communication method according to an embodiment of the present application;

FIG. 8 is a schematic flowchart of a secure communication method according to an embodiment of the present application;

FIG. 9 is a sequence diagram of a secure communication method according to an embodiment of the present application;

FIG. 10 is a block diagram of a secure communication apparatus according to an embodiment of the present application;

FIG. 11 is a block diagram of a secure communication apparatus according to an embodiment of the present application;

FIG. 12 is a block diagram of a secure communication apparatus according to an embodiment of the present application;

FIG. 13 is a schematic structural diagram of a communication apparatus according to an embodiment of the present application; and

FIG. 14 is a schematic structural diagram of a chip provided by an embodiment of the present application.

### DETAILED DESCRIPTION

The embodiments of the present application are described in detail below. Examples of the embodiments are shown in the accompanying drawings, where the same or similar reference numerals throughout represent the same or similar elements or elements with the same or similar functions. The embodiments described below with reference to the drawings are exemplary and are intended to explain the present application, but should not be construed as limiting the present application. It should be noted that, as long as there is no conflict, the embodiments and the features in the embodiments of the present application can be combined with each other.

The terms used in the embodiments of the present disclosure are for the purpose of describing specific embodiments only and are not intended to limit the embodiments of the present disclosure. As used in the embodiments and the appended claims of the present disclosure, the singular forms “a/an”, and “the” are intended to include the plural forms as well, unless the context clearly dictates otherwise. It will also be understood that the term “and/or” as used herein refers to and includes any or all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “upon” or “in response to determining.” To facilitate understanding, the terms involved in the embodiments are first introduced.

### 1. Authentication and Key Management Application based on 3GPP Credentials (AKMA)

One important feature introduced in 5G security technology is to use the authentication and security mechanism of the operator network to provide authentication and session key capabilities for third-party applications, so as to ensure session security between the user equipment (UE) and the application server.

### 2. AKMA Anchor Function (AAnF)

It is located in the home network, and is mainly used to generate a session key between the UE and the application server, and to maintain the security context with the UE. The AKMA technology provides the end-to-end security protection from users to applications for 5g networks.

### 3. Authentication Server Function (AUSF)

AUSF is used to receive a request from an access and mobility management function (AMF) for authentication of the UE, and by requesting the key from UDM, and then forwarding the key issued by UDM to AMF, the authentication processing is performed.

In the following embodiments, AKMA, AAnF and AUSF may be network function modules on the core network side.

The 3rd Generation Partnership Project (3GPP) SA3 specifies authentication and key management for applications based on 3GPP Credentials (AKMA) in 3GPP TS 33.535 [1]. The AKMA feature has been used as a solution to protect communication between the UE and the application function (AF) in the scenarios of ProSe, MSGin5G, etc.

3GPP TS 33.222 specifies the use of an authentication proxy in the General Bootstrapping Architecture (GBA), where the authentication proxy (AP) is a proxy that resides between the UE and the Application Server (AS). It helps to reduce the consumption of authentication vectors and/or to minimize sequence number (SQN) synchronization failures, and relieves the security tasks of AS. This is beneficial when different application servers (or application functions in AKMA) reside in the same trust domain or in the same edge node. Through the AP, these application servers can rely on the AP to execute the AKMA procedure, which has a cost-saving advantage over the case where each application server executes the AKMA procedure independently. Since AKMA is adopted as a solution in Mobile Edge Computing (MEC), and it is possible that different application servers reside in the same edge cloud or belong to the same service provider, it is beneficial to consider the feasibility of introducing a similar proxy in AKMA. However, there is no existing solution to support Authentication Proxy (AP) in AKMA scenarios.

To this end, this embodiment proposes a secure communication method and apparatus, which provides an effective solution to support authentication proxy in AKMA scenarios, and can meet more service requirements on the premise of ensuring communication security.

The secure communication method and apparatus provided by the present application will be introduced in detail below with reference to the accompanying drawings.

FIG. 1 shows a schematic flowchart of a secure communication method according to an embodiment of the present application. As shown in FIG. 1, this method is applied to an AKMA authentication proxy and may include the following steps.

In step 101: the AKMA authentication proxy receives a service request of a target application server sent by a UE.

The service request may carry identification information of the target application server and an A-KID of the UE. The A-KID is an AKMA key identifier. Before sending the service request, the UE side may first generate an AKMA anchor key (K_{AKMA}) and the A-KID based on a key KAUSE of the Authentication Server Function (AUSF) network element, so that the A-KID is carried when sending the service request.

Optionally, the identification information of the target application server may at least include: a FQDN, a Ua* security protocol identifier, an IP address, a port number, etc. of the target application server. For example, the identification information of the target application server may include: an application function identification (AS-ID), a Domain Name System (DNS) name, an IP address of the target application server, a port number of the target application server, etc. Among them, the application function identification may consist of the FQDN and the Ua* security protocol identifier of the target application server. The Ua* security protocol identifier may be used to determine the security protocol that the target application server will use with the UE.

In this embodiment, the AKMA authentication proxy may have the same application function identification as the target application server. The application function identification includes: the FQDN and the Ua* security protocol identifier corresponding to the application function. In this way, the target application server may share the same domain name address with the AKMA authentication proxy, so that when the UE sends a service request to the target application server, the service request to be sent to the target application server is first sent to the AKMA authentication proxy, and authentication and authorization is performed through the AKMA authentication proxy. Specifically, the process of step 102 is performed.

In step 102: the AKMA authentication proxy performs authentication and authorization on the UE according to the A-KID of the UE and the identification information of the target application server, and determines whether to authorize the UE to access the target application server.

After receiving the service request sent by the UE to the target application server, the AKMA authentication proxy may perform authentication and authorization according to the pre-configured policy, the A-KID of the UE and the identification information of the target application server, and determine whether to authorize the UE to access the target application server corresponding to the identification information. If the UE is not authorized to access the target application server through authentication, an error code may be returned to the UE to inform the UE of the failure to access the target application server. If the UE is authorized to access the target application server through authentication, the process shown in step 103 is performed.

In step 103: in response to authorizing the UE to access the target application server, the AKMA authentication proxy forwards the service request and an authentication result of the UE to the target application server.

After receiving the service request from the UE and the authentication result of the UE forwarded by the AKMA authentication proxy, the target application server can confirm that the UE has been authenticated and authorized by the AKMA authentication proxy according to the authentication result of the UE, and can then safely process the service request, and returns a service response of the service request to the UE through the AKMA authentication proxy. Correspondingly, after forwarding the service request and the authentication result of the UE to the target application server, the AKMA authentication proxy may send the service response of the target application server to the UE.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

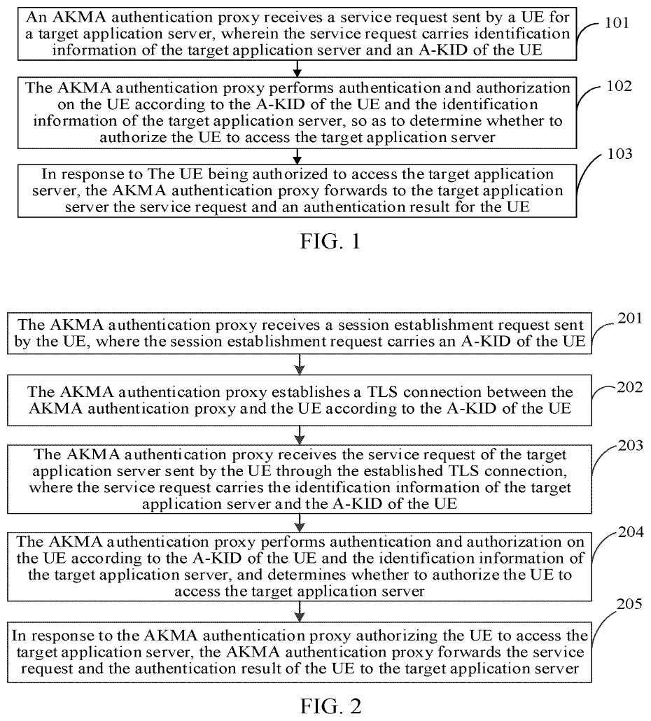

FIG. 2 shows a schematic flowchart of a secure communication method according to an embodiment of the present application. The method is applied to the AKMA authentication proxy. Based on the embodiment shown in FIG. 1, as shown in FIG. 2, the method may include the following steps.

In step 201: the AKMA authentication proxy receives a session establishment request sent by the UE, where the session establishment request carries an A-KID of the UE.

In step 202: the AKMA authentication proxy establishes a TLS connection between the AKMA authentication proxy and the UE according to the A-KID of the UE.

Optionally, according to the A-KID of the UE, the process of establishing the TLS connection between the AKMA authentication proxy and the UE may specifically include: the AKMA authentication proxy sending an AKMA application key request to the AKMA anchor function (AAnF), where the key request may carry the A-KID of the UE and an application function identification of the AKMA authentication proxy, and the application function identification of the AKMA authentication proxy (has the same application function identification as the target application server) includes: FQDN, Ua* security protocol identifier; the AKMA authentication proxy receiving a first key K_{AF} returned by AAnF according to the A-KID of the UE and the application function identification of the AKMA authentication proxy; and then performing mutual authentication between the AKMA authentication proxy and the UE, and establishing a TLS connection between the AKMA authentication proxy and the UE based on the first key K_{AF} and a second key K_{AF} on the UE side. Through this optional method, the TLS connection between the AKMA authentication proxy and the UE can be accurately established, ensuring the smooth progress of subsequent secure communications between the UE and the AKMA authentication proxy. On the premise that the TLS connection is established between the UE and the AKMA authentication proxy, the AKMA authentication proxy can forward the service request of the UE to the target application server, thereby effectively ensuring the security of the communication between the UE and the target application server.

For example, on the AKMA authentication proxy side, the AKMA authentication proxy sends an AKMA application key request carrying the A-KID of the UE to AAnF. AAnF finds the corresponding first anchor key K_{AKMA} according to the A-KID. Then AAnF can derive the AKMA application key of the AKMA authentication proxy from the first anchor key K_{AKMA}, that is, the first key K_{AF} on the AKMA authentication proxy side. On the UE side, a second anchor key K_{AKMA} can be obtained in advance based on the key K_{AUSF} of the AUSF network element. The second anchor key K_{AKMA} is used to combine with the identification information of the target application server (such as FQDN and other information) to derive the second key K_{AF}. Subsequently, based on the first key K_{AF} and the second key K_{AF} on the UE side, mutual authentication between the AKMA authentication proxy and the UE can be performed (such as determining whether the first key K_{AF} on the KMA authentication proxy side and the second key K_{AF} on the UE side are the same), and a TLS connection between the AKMA authentication proxy and the UE is established.

In step 203: through the established TLS connection, the AKMA authentication proxy receives the service request of the target application server sent by the UE. The service request carries the identification information of the target application server and the A-KID of the UE.

In step 204: the AKMA authentication proxy performs authentication and authorization on the UE according to the A-KID of the UE and the identification information of the target application server, and determines whether to authorize the UE to access the target application server.

The specific implementation process of step 204 is the same as step 102, and will not be described again here.

In step 205: in response to the AKMA authentication proxy authorizing the UE to access the target application server, the AKMA authentication proxy forwards the service request and the authentication result of the UE to the target application server.

The specific implementation process of step 205 is the same as step 103, and will not be described again here.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

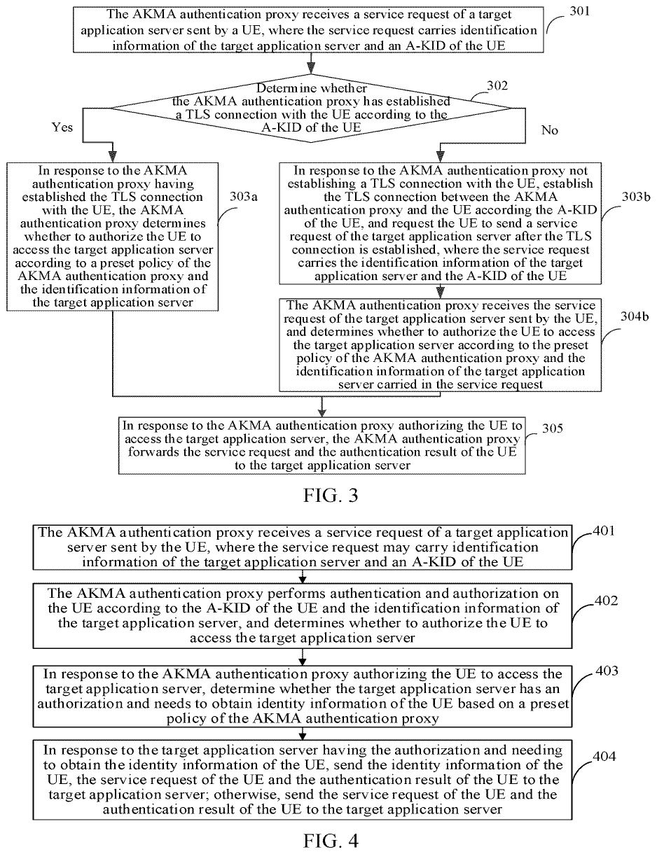

FIG. 3 shows a schematic flowchart of a secure communication method according to an embodiment of the present application. The method is applied to the AKMA authentication proxy. Based on the embodiment shown in FIG. 1, as shown in FIG. 3, the method may include the following steps.

In step 301: the AKMA authentication proxy receives a service request of a target application server sent by a UE.

The service request may carry identification information of the target application server and an A-KID of the UE.

In this embodiment, in response to the service request of the target application server sent by the UE, the AKMA authentication proxy first determines whether the AKMA authentication proxy has established a secure TLS connection with the UE, and performs corresponding steps based on the determination result.

In step 302: it is determined whether the AKMA authentication proxy has established a TLS connection with the UE according to the A-KID of the UE.

In step 303a: in response to the AKMA authentication proxy having established the TLS connection with the UE, the AKMA authentication proxy determines whether to authorize the UE to access the target application server according to a pre-configured policy of the AKMA authentication proxy and the identification information of the target application server.

The UE attempts to connect to the target application server supported by the AKMA authentication proxy. The AKMA authentication proxy needs to check whether a TLS connection has been established with the UE. If the AKMA authentication proxy has established a TLS connection with the UE, it means that the AKMA authentication proxy and the UE can trust each other, and according to the pre-configured policy of the AKMA authentication proxy and the identification information of the target application server, the UE can be authorized to access the target application server. The pre-configured policy may be set according to actual service requirements. If the target application server corresponding to the identification has no access restrictions, and the AKMA authentication proxy has established a TLS connection with the UE, then the AKMA authentication proxy can authorize the UE to access the target application server.

In step 303b parallel to step 303a: in response to the AKMA authentication proxy not establishing a TLS connection with the UE, the TLS connection between the AKMA authentication proxy and the UE is established according to the A-KID of the UE, and the UE is required to send a service request of the target application server after the TLS connection is established, where the service request carries the identification information of the target application server and the A-KID of the UE.

In this embodiment, if the AKMA authentication proxy does not establish a TLS connection with the UE, it is necessary to establish a TLS connection between the AKMA authentication proxy and the UE according to the A-KID of the UE, and the UE is required to resend the service request. This is because that there is no TLS connection when sending the service request for the first time, and the message may be tampered with during this process. Since the A-KID can be verified by the network side, tampering can be found by the AKMA authentication proxy. The tampering of the identification information of the target application server cannot be found, and thus it can only be transmitted after the TLS secure connection is established. Therefore, a TLS connection is established between the AKMA authentication proxy and the UE, and the UE is required to resend the service request, carrying the identification information of the target application server and the A-KID of the UE.

Optionally, according to the A-KID of the UE, the process of establishing a TLS connection between the AKMA authentication proxy and the UE may specifically include: the AKMA authentication proxy sending an AKMA application key request to the AKMA anchor function (AAnF), where the key request may carry the A-KID of the UE and the application function identification of the AKMA authentication proxy, and the application function identification of the AKMA authentication proxy (has the same application function identification as the target application server) includes: FQDN, Ua* security protocol identifier; the AKMA authentication proxy receiving the first key K_{AF} returned by AAnF according to the A-KID of the UE and the application function identification of the AKMA authentication proxy; and then performing mutual authentication between the AKMA authentication proxy and the UE based on the first key K_{AF} and the second key K_{AF} on the UE side, and establishing a TLS connection between the AKMA authentication proxy and the UE. The specific implementation process is similar to the example content in step 202, and will not be described again here.

Through this optional method, the TLS connection between the AKMA authentication proxy and the UE can be accurately established, ensuring the smooth progress of subsequent secure communications between the UE and the AKMA authentication proxy. Only when the TLS connection is established between the UE and the AKMA authentication proxy can the AKMA authentication proxy forward the service request of the UE to the target application server, thereby effectively ensuring the security of the communication between the UE and the target application server.

In step 304b: the AKMA authentication proxy receives the service request of the target application server sent by the UE, and determines whether to authorize the UE to access the target application server according to the pre-configured policy of the AKMA authentication proxy and the identification information of the target application server carried in the service request.

In step 305: in response to the AKMA authentication proxy authorizing the UE to access the target application server, the AKMA authentication proxy forwards the service request and the authentication result of the UE to the target application server.

It should be noted that although the embodiment shown in FIG. 3 is described based on the embodiment shown in FIG. 1, similarly, the embodiment shown in FIG. 3 may also be based on the embodiment shown in FIG. 2, which will not be discussed here.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

FIG. 4 is a schematic flowchart of a secure communication method according to an embodiment of the present application. The method is applied to the AKMA authentication proxy. Based on the embodiment shown in FIG. 1, as shown in FIG. 4, the method may include the following steps.

In step 401: the AKMA authentication proxy receives a service request of a target application server sent by the UE.

The service request may carry identification information of the target application server and an A-KID of the UE.

In step 402: the AKMA authentication proxy performs authentication and authorization on the UE according to the A-KID of the UE and the identification information of the target application server, and determines whether to authorize the UE to access the target application server.

The specific implementation process of step 402 is the same as step 102, and will not be described again here.

In step 403: in response to the AKMA authentication proxy authorizing the UE to access the target application server, based on a pre-configured policy of the AKMA authentication proxy, it is determined whether the target application server has an authorization and needs to obtain identity information of the UE.

The pre-configured policy may be configured in advance to determine whether the target application server has the authorization and needs to obtain the identity information of the UE to meet specific service scenario requirements. If the target application server needs the identity information of the UE, it can obtain the service corresponding to the identity information and return it to the UE, etc.

In step 404: in response to the target application server having the authorization and needing to obtain the identity information of the UE, the identity information of the UE, the service request of the UE and the authentication result of the UE are sent to the target application server; otherwise, the service request of the UE and the authentication result of the UE are sent to the target application server.

The identity information of the UE may include: a Generic Public Subscription Identifier (GPSI) and/or a Subscription Permanent Identifier (SUPI) of the UE, etc. For example, if the target application server needs to obtain the identity information of the UE, the AKMA authentication proxy sends the service request of the UE, the SUPI/GPSI of the UE and the authentication result of the UE to the target application server; and if the target application server does not need the identity information of the UE, then the AKMA authentication proxy sends the service request of the UE and the authentication result of the UE to the target application server.

If the target application server is not within the 3rd Generation Partnership Project (3GPP) operator domain, for the corresponding service requirements, optionally, sending the identity information of the UE, the service request of the UE and the authentication result of the UE to the target application server in response to that the target application server has the authorization and needs to obtain the identity information of the UE specifically includes: in response to the target application server not being within the 3GPP operator domain, sending the GPSI of the UE to the target application server. For example, if the target application server is not in the 3GPP operator domain, the AKMA authentication proxy may only send the Generic Public Subscription identifier of the UE, that is, the GPSI of the UE, to the target application server.

Further optionally, after sending the identity information of the UE, the service request of the UE and the authentication result of the UE to the target application server, the method in this embodiment may also include: sending corresponding authorization information and service response to the UE through service response information returned by the target application server. Through this optional method, the UE side can learn in time that its identity information needs to be obtained, and can feed it back to the user, etc.

It should be noted that although the embodiment shown in FIG. 4 is described based on the embodiment shown in FIG. 1, similarly, the embodiment shown in FIG. 4 can also be based on the embodiment shown in FIG. 2 and/or FIG. 3, which will be elaborated here.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

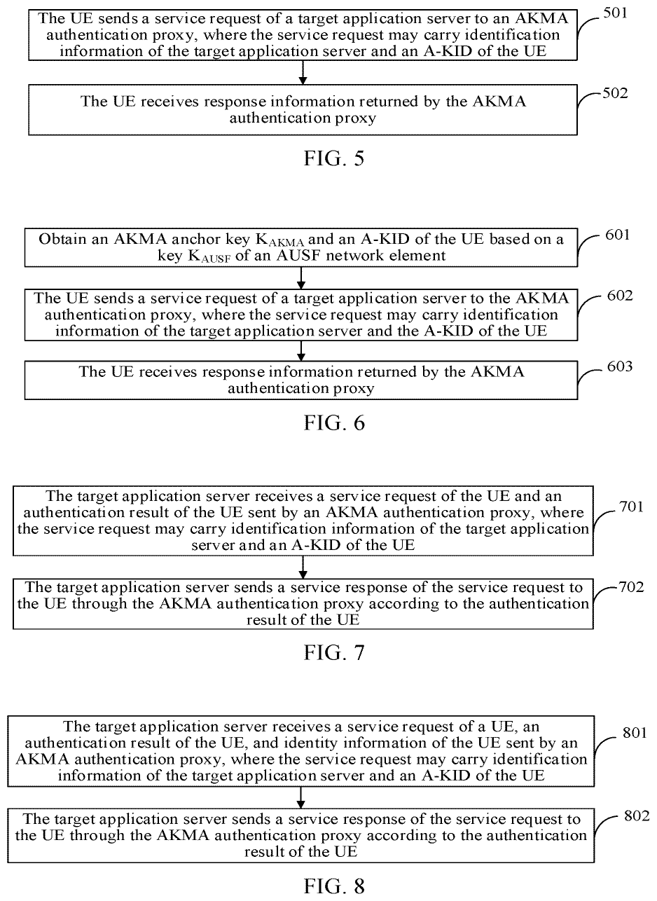

FIG. 5 is a schematic flowchart of a secure communication method according to an embodiment of the present application. As shown in FIG. 5, the method is applied to user equipment (UE) and may include the following steps.

In step 501: the UE sends a service request of a target application server to an AKMA authentication proxy.

The service request may carry identification information of the target application server and an A-KID of the UE, that is, the AKMA key identifier. Optionally, the identification information of the target application server may at least include: a FQDN, a Ua* security protocol identifier, an IP address, a port number, etc. of the target application server. For example, the identification information of the target application server may include: an application function identification, a DNS name, an IP address of the target application server, a port number of the target application server, etc. The application function identification may consist of the FQDN and the Ua* security protocol identifier of the target application server.

For this embodiment, the AKMA authentication proxy may have the same application function identification as the target application server. The application function identification includes: the FQDN and the Ua* security protocol identifier corresponding to the application function, so that the target application server may share the same domain name address with the AKMA authentication proxy. Accordingly, optionally, step 501 may specifically include: obtaining an address of the AKMA authentication proxy through the identification information of the target application server; and then sending the service request according to the address of the AKMA authentication proxy.

Through this optional method, when the UE sends a service request to the target application server, the service request to be sent to the target application server is first sent to the AKMA authentication proxy, and authentication and authorization are performed through the AKMA authentication proxy. Only when the AKMA authentication proxy authorizes to access to the target application server, the AKMA authentication proxy can forward the service request to the target application server, which improves the security of communication between the UE and the target application server. For the specific authentication and authorization process, the implementation process of the methods shown in FIGS. 1 to 4 may be referred to, and will not be described again here.

In step 502: the UE receives response information returned by the AKMA authentication proxy.

Optionally, step 502 may specifically include: the UE receiving error code information sent by the AKMA authentication proxy or a service response returned by the target application server. For example, after authentication and authorization by the AKMA authentication proxy, if the UE fails to pass the authentication and authorization to access the target application server, the UE will receive an error code returned by the AKMA authentication proxy to inform the UE of the failure to access the target application server. If the UE passes authentication and authorization and accesses the target application server, the UE can receive a service response from the target application server through the AKMA authentication proxy. If during the process, the AKMA authentication proxy determines that the target application server has the authorization and needs to obtain the identity information of the UE, it may send the identity information of the UE, the service request of the UE and the authentication result of the UE to the target application server. Correspondingly, the UE may receive from the AKMA authentication proxy the corresponding authorization information and service response sent to the UE through the service response information returned by the target application server. Then, the UE side can know in time that its identity information needs to be obtained, and can feedback it to the user, etc.

By applying the secure communication method provided by this embodiment, the UE first sends the service request of the target application server to the AKMA authentication proxy, and after being authenticated and authorized by the AKMA authentication proxy, the service request and the authentication result of the UE are forwarded to the target application server for processing, which is equivalent to providing an effective solution to support authentication proxy in the AKMA scenario. Moreover, the same AKMA authentication proxy can correspond to a plurality of target application servers, so that the UE can communicate with a plurality of target application servers through one AKMA authentication proxy, which improves the communication efficiency between the UE and the plurality of target application servers on the premise of ensuring communication security, and can meet more service requirements.

FIG. 6 shows a schematic flowchart of a secure communication method according to an embodiment of the present application. The method is applied to user equipment (UE). Based on the embodiment shown in FIG. 5, as shown in FIG. 6, the method may include the following steps.

In step 601: based on a key K_{AUSF} of an AUSF network element, an AKMA anchor key K_{AKMA} and an A-KID of the UE are obtained.

K_{AKMA} may be used to obtain a key K_{AF} in combination with the identification information of the target application server. The key K_{AF} is used to establish a TLS connection with the AKMA authentication proxy.

For this embodiment, before initiating communication with the AKMA authentication proxy, the UE can derive K_{AKMA} and the A-KID of the UE based on the key K_{AUSF} of the AUSF network element. When the UE initiates communication with the AKMA authentication proxy, the derived A-KID may be included in the application session establishment request message (for details, please refer to clause 6.1 of 3GPP TS 33.535). The UE may obtain the key K_{AF} before or after sending the message, for example, obtains the key K_{AF} on the UE side by combining K_{AKMA} with the identification information of the target application server.

The AKMA authentication proxy receives the application session establishment request initiated by the UE and can obtain the A-KID of the UE. The AKMA authentication proxy sends an AKMA application key request carrying the A-KID of the UE to AAnF. If the AKMA authentication proxy is not within the 3GPP operator domain, the AKMA authentication proxy may send a request to AAnF through the network exposure function (NEF). After AAnF determines that it can provide services to the AKMA authentication proxy based on a pre-configured policy, AAnF determines whether the corresponding K_{AKMA} can be found according to the A-KID. If it can find the KAKMA, and AAnF does not already have key K_{AF} on the AKMA authentication proxy side, then AAnF can derive from the K_{AKMA} the AKMA application key of the AKMA authentication proxy, that is, the key K_{AF} on the AKMA authentication proxy side. If the corresponding K_{AKMA} cannot be found according to the A-KID, an error response is fed back to the AKMA authentication proxy, and then the AKMA authentication proxy may feed back the response information of session establishment failure to the UE, so that the UE can subsequently send a new application session establishment request with the latest A-KID to the AKMA authentication proxy for retry.

After the AKMA authentication proxy obtains the key K_{AF} on the AKMA authentication proxy side, it can use the key K_{AF} to authenticate the UE, such as comparing it with the key K_{AF} on the UE side. If the authentication is successful, a TLS connection between the UE and the AKMA authentication proxy can be established, and then the two parties can realize secure communication.

In step 602: the UE sends a service request of a target application server to the AKMA authentication proxy.

The service request may carry identification information of the target application server and an A-KID of the UE.

After the TLS connection between the UE and the AKMA authentication proxy is successfully established, the AKMA authentication proxy, after receiving the service request of the UE, authorizes the UE to access the target application server according to the pre-configured policy, and sends the service request of the UE and the authentication result of the UE to the target application server for processing.

In step 603: the UE receives response information returned by the AKMA authentication proxy.

For the description and specific details of the above steps 602 to 603, the implementation process of the methods shown in FIGS. 1 to 3 may be referred to, and will not be described again here.

By applying the secure communication method provided by this embodiment, the UE first sends the service request of the target application server to the AKMA authentication proxy, and after being authenticated and authorized by the AKMA authentication proxy, the service request and the authentication result of the UE are forwarded to the target application server for processing, which is equivalent to providing an effective solution to support authentication proxy in the AKMA scenario. Moreover, the same AKMA authentication proxy can correspond to a plurality of target application servers, so that the UE can communicate with a plurality of target application servers through one AKMA authentication proxy, which improves the communication efficiency between the UE and the plurality of target application servers on the premise of ensuring the communication security, and can meet more service requirements.

FIG. 7 shows a schematic flowchart of a secure communication method according to an embodiment of the present application. As shown in FIG. 7, this method is applied to a target application server and may include the following steps.

In step 701: the target application server receives a service request of the UE and an authentication result of the UE sent by an AKMA authentication proxy.

The service request of the UE may carry identification information of the target application server and an A-KID of the UE, that is, an AKMA key identifier. Optionally, the identification information of the target application server may at least include: a FQDN, a Ua* security protocol identifier, an IP address, a port number, etc. of the target application server. For example, the identification information of the target application server may include: an application function identification, a DNS name, an IP address of the target application server, a port number of the target application server, etc. The application function identification may consist of the FQDN and the Ua* security protocol identifier of the target application server.

In step 702: the target application server sends a service response of the service request to the UE through the AKMA authentication proxy according to the authentication result of the UE.

Optionally, step 702 may specifically include: in response to the UE passing the authentication and authorization of the AKMA authentication proxy, the target application server returning a service response to the UE through the AKMA authentication proxy. For example, after receiving the service request from the UE and the authentication result of the UE forwarded by the AKMA authentication proxy, the target application server can confirm that the UE has been authenticated and authorized by the AKMA authentication proxy according to the authentication result of the UE, and thus can securely process the service request and send a service response of the service request to the UE through the AKMA authentication proxy.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

FIG. 8 shows a schematic flowchart of a secure communication method according to an embodiment of the present application. This method is applied to the target application server. Based on the embodiment shown in FIG. 7, as shown in FIG. 8, the method may include the following steps.

In step 801: the target application server receives a service request of a UE, an authentication result of the UE, and identity information of the UE sent by an AKMA authentication proxy.

After receiving the service request of the UE, the AKMA authentication proxy authenticates and authorizes the UE according to the A-KID of the UE and the identification information of the target application server, determines that the UE is authorized to access the target application server, and in response to that the AKMA authentication proxy authorizes the UE to access the target application server, determines whether the target application server has the authority and needs to obtain the identity information of the UE based on the pre-configured policy of the AKMA authentication proxy. If the target application server has the authority and needs to obtain the identity information of the UE, then the target application server may receive the service request of the UE, the authentication result of the UE, and the identity information of the UE sent by the AKMA authentication proxy. The identity information of the UE may include: GPSI/SUPI of the UE.

In step 802: the target application server sends a service response of the service request to the UE through the AKMA authentication proxy according to the authentication result of the UE.

If the UE is authorized by the AKMA authentication proxy to access the target application server, the target application server can process the service request of the UE, such as processing the service request according to the identity information of the UE, and then feed back the service response information of the service request to the AKMA authentication proxy. The AKMA authentication proxy sends corresponding authorization information and service response to the UE through the service response information returned by the target application server.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

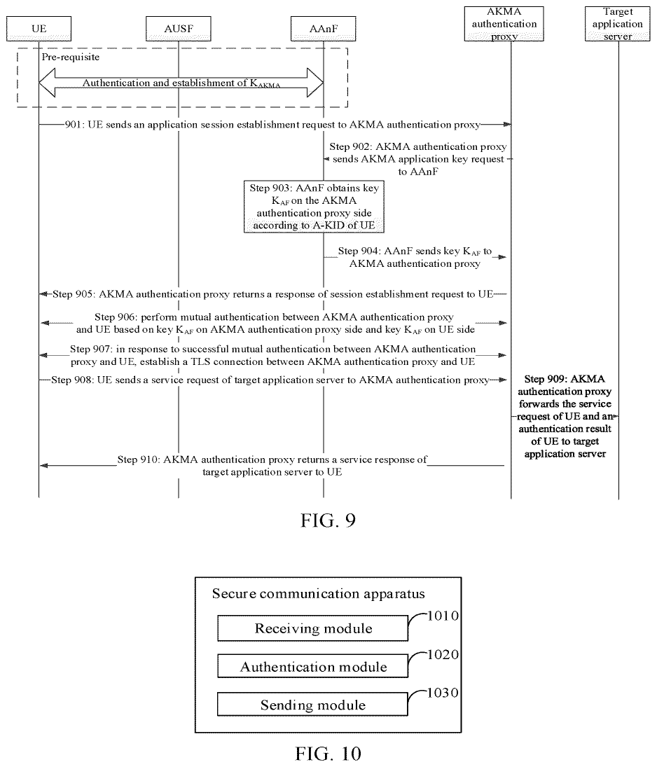

FIG. 9 is a sequence diagram of a secure communication method according to an embodiment of the present application. The method is applied to a secure communication system. The system includes: an AKMA authentication proxy, a user equipment (UE), and a target application server. The AKMA authentication proxy receives a service request of the target application server sent by the UE, where the service request carries identification information of the target application server and an A-KID of the UE; the AKMA authentication proxy authenticates and authorizes the UE according to the A-KID and the identification information of the target application server, determines whether to authorize the UE to access the target application server, and in response to authorizing the UE to access the target application server, forwards the service request and an authentication result of the UE to the target application server; the target application server sends a service response of the service request to the UE through the AKMA authentication proxy according to the authentication result of the UE.

Referring to FIG. 9, the method includes the following steps.

In step 901: the UE sends an application session establishment request to the AKMA authentication proxy.

The application session establishment request carries the A-KID of the UE. Before the UE initiates communication with the AKMA authentication proxy, it can derive K_{AKMA} and the A-KID of the UE based on the key K_{AUSF} of the AUSF network element. When the UE initiates communication with the AKMA authentication proxy, the derived A-KID may be included in the application session establishment request.

In step 902: the AKMA authentication proxy sends an AKMA application key request to AAnF.

The application key request carries the A-KID of the UE. The AKMA authentication proxy receives the application session establishment request initiated by the UE and can obtain the A-KID of the UE. The AKMA authentication proxy sends an AKMA application key request carrying the A-KID of the UE to the AAnF.

In step 903: AAnF obtains the key K_{AF} on the AKMA authentication proxy side according to the A-KID of the UE.

After AAnF determines that it can provide services to the AKMA authentication proxy based on the pre-configured policy, AAnF determines whether the corresponding K_{AKMA} can be found according to the A-KID. If it can find the KAKMA, and AAnF does not already have a key K_{AF} on the AKMA authentication proxy side, then AAnF can derive from the K_{AKMA} the AKMA application key of the AKMA authentication proxy, that is, the key K_{AF} on the AKMA authentication proxy side. If the corresponding K_{AKMA} cannot be found according to the A-KID, an error response is fed back to the AKMA authentication proxy, and then the AKMA authentication proxy can feed back response information of session establishment failure to the UE, so that the UE can subsequently send a new application session establishment request with the latest A-KID to the AKMA authentication proxy for retrying.

In step 904: AAnF sends the key K_{AF} to the AKMA authentication proxy.

In step 905: the AKMA authentication proxy returns a response of the session establishment request to the UE.

In step 906: mutual authentication between the AKMA authentication proxy and the UE is performed based on the K_{AF} on the AKMA authentication proxy side and the key K_{AF} on the UE side.

For example, by comparing the key K_{AF} based on the AKMA authentication proxy side and the key K_{AF} on the UE side, if the keys K_{AF} on both sides are consistent, it can be determined that the mutual authentication between the AKMA authentication proxy and the UE is successful.

In step 907: in response to successful mutual authentication between the AKMA authentication proxy and the UE, a TLS connection between the AKMA authentication proxy and the UE is established.

In step 908: the UE sends a service request of a target application server to the AKMA authentication proxy.

Since the TLS connection has been established between the AKMA authentication proxy and the UE, the AKMA authentication proxy determines whether to authorize the UE to access the target application server according to the pre-configured policy and the identification information of the target application server. If the AKMA authentication proxy determines to authorize the UE to access the target application server, the process shown in step 909 will be executed.

In step 909: the AKMA authentication proxy forwards the service request of the UE and an authentication result of the UE to the target application server.

After receiving the service request from the UE and the authentication result of the UE forwarded by the AKMA authentication proxy, the target application server can confirm that the UE has been authenticated and authorized by the AKMA authentication proxy according to the authentication result of the UE, and can then safely process the service request, and returns the service response of the service request to the UE through the AKMA authentication proxy.

In step 910: the AKMA authentication proxy returns the service response of the target application server to the UE.

By applying the secure communication method provided by this embodiment, it is equivalent to providing an effective solution to support the authentication proxy in the AKMA scenario. The UE first sends the service request of the target application server to the AKMA authentication proxy, and after passing the authentication and authorization through the AKMA authentication proxy, the service request and the authentication result of the UE are forwarded to the target application server for processing. The same AKMA authentication proxy can correspond to a plurality of target application servers, so that the UE can communicate with a plurality of target application servers through one AKMA authentication proxy. Under the premise of ensuring the communication security, the communication efficiency between the UE and the plurality of target application servers is improved, and more service requirements can be met.

In the above embodiments provided by the present application, the methods provided by the embodiments of the present application are introduced from the perspectives of network device and user equipment respectively. In order to implement each function in the methods provided by the above embodiments of the present application, the network device and the user equipment may include a hardware structure and a software module to implement the above functions in the form of hardware structure, software module, or hardware structure plus software module. A certain function among the above functions can be executed by a hardware structure, a software module, or a hardware structure plus a software module.

Corresponding to the secure communication methods provided by the above-mentioned embodiments, the present application also provides a secure communication apparatus. Since the secure communication apparatus provided by the embodiments of the present application corresponds to the secure communication methods provided by the above-mentioned embodiments, the implementations of the secure communication method are also applicable to the secure communication apparatus provided in this embodiment, and will not be described in detail in this embodiment.

FIG. 10 is a schematic structural diagram of a secure communication apparatus provided by an embodiment of the present application. The secure communication apparatus may be applied in an AKMA authentication proxy.

As shown in FIG. 10, the apparatus may include: a receiving module 1010, configured to receive a service request of a target application server sent by a UE, where the service request carries identification information of the target application server and an AKMA key identifier (A-KID) of the UE; an authentication module 1020, configured to authenticate and authorize the UE according to the A-KID and the identification information of the target application server, and determine whether to authorize the UE to access the target application server; a sending module 1030, configured to, in response to authorizing the UE to access the target application server, forward the service request and an authentication result of the UE to the target application server.

In some embodiments, the receiving module 1010 is further configured to, before receiving the service request of the target application server sent by the user equipment (UE), receive a session establishment request sent by the UE, where the session establishment request carries the A-KID of the UE; establish a TLS connection with the UE according to the A-KID of the UE; receiving the service request of the target application server sent by the UE includes: receiving the service request sent by the UE through the established TLS connection.

In some embodiments, the identification information of the target application server at least includes: a FQDN, a Ua* security protocol identifier, an IP address, and a port number.

In some embodiments, the authentication module 1020 is configured to determine whether a TLS connection has been established with the UE; in response to the TLS connection having been established with the UE, according to a pre-configured policy of the AKMA authentication proxy and the identification information of the target application server, determine whether the UE is authorized to access the target application server.

In some embodiments, the authentication module 1020 is further configured to, in response to have not been establishing a TLS connection with the UE, establish a TLS connection with the UE according to the A-KID, and request the UE to send a service request of the target application server after establishing the TLS connection. The service request carries the identification information of the target application server and the A-KID of the UE.

In some embodiments, the authentication module 1020 is further configured to send an AKMA application key request to the AKMA anchor function (AAnF), where the key request carries the A-KID and an application function identification of the AKMA authentication proxy, the application function identification of the AKMA authentication proxy includes: a FQDN, a Ua* security protocol identifier; receive a first key K_{AF} returned by the AAnF according to the A-KID and the application function identification of the AKMA authentication proxy; based on the first key K_{AF} and a second key K_{AF} on the UE side, perform mutual authentication with the UE and establish a TLS connection with the UE.

In some embodiments, the sending module 1030 is further configured to send a service response of the target application server to the UE after sending the service request and the authentication result of the UE to the target application server.

In some embodiments, the sending module 1030 is specifically configured to determine whether the target application server has the authorization and needs to obtain identity information of the UE based on a pre-configured policy of the AKMA authentication proxy; in response to the target application server having the authorization and needing to obtain the identity information of the UE, send the identity information of the UE, the service request and the authentication result of the UE to the target application server; otherwise, send the service request and the authentication result of the UE to the target application server.

In some embodiments, the sending module 1030 is specifically configured to send the corresponding authorization information and service response to the UE through the service response information returned by the target application server after sending the identity information of the UE, the service request and the authentication result of the UE to the target application server.

In some embodiments, the sending module 1030 is specifically configured to send a generic public subscription identifier (GPSI) of the UE to the target application server in response to that the target application server is not within the 3GPP operator domain.

In some embodiments, the AKMA authentication proxy and the target application server have the same application function identification, and the application function identification includes: the FQDN and the Ua* security protocol identifier corresponding to the application function.

This embodiment is equivalent to providing an effective solution to support authentication proxy in the AKMA scenario, and the same AKMA authentication proxy can correspond to a plurality of target application servers, so that the UE can communicate with a plurality of target application servers through one AKMA authentication proxy. On the premise of ensuring the communication security, the communication efficiency between the UE and the plurality of target application servers is improved, and more service requirements can be met.

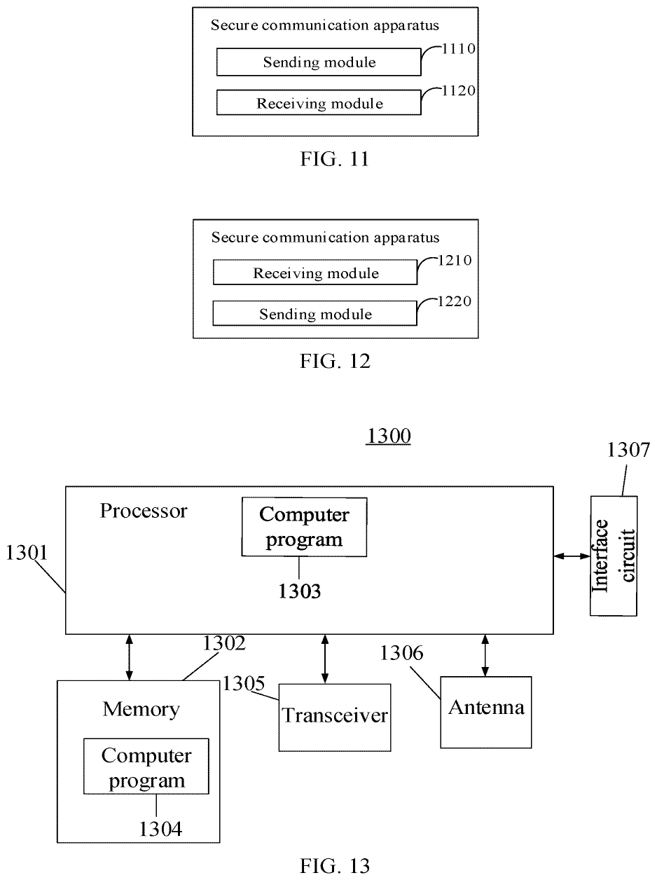

FIG. 11 is a schematic structural diagram of a secure communication apparatus provided by an embodiment of the present application. The secure communication apparatus may be used in a user equipment (UE).

As shown in FIG. 11, the apparatus may include: a sending module 1110, configured to send a service request of the target application server to an authentication and key management for applications (AKMA) authentication proxy, where the service request carries identification information of the target application server and an AKMA key identifier (A-KID) of the UE; and a receiving module 1120, configured to receive response information returned by the AKMA authentication proxy.

In some embodiments, the sending module 1110 is further configured to obtain an AKMA anchor key K_{AKMA} and A-KID based on a key K_{AUSF} of the authentication service function (AUSF) network element before sending the service request of the target application server to the AKMA authentication proxy; where K_{AKMA} is used to obtain the key K_{AF} in combination with the identification information of the target application server, and the key K_{AF} is used to establish a transport layer security protocol (TLS) connection with the AKMA authentication proxy.

In some embodiments, the sending module 1110 is specifically configured to obtain an address of the AKMA authentication proxy through the identification information of the target application server, where the identification information of the target application server at least includes: a FQDN and a Ua* security protocol identifier, an IP address, a port number of the target application server; send a service request according to the address of the AKMA authentication proxy.

In some embodiments, the receiving module 1120 is specifically configured to receive error code information sent by the AKMA authentication proxy or a service response returned by the target application server.

This embodiment is equivalent to providing an effective solution to support authentication proxy in the AKMA scenario, and the same AKMA authentication proxy can correspond to a plurality of target application servers, so that the UE can communicate with a plurality of target application servers through one AKMA authentication proxy. On the premise of ensuring the communication security, the communication efficiency between the UE and the plurality of target application servers is improved, and more service requirements can be met.

FIG. 12 is a schematic structural diagram of a secure communication apparatus provided by an embodiment of the present application. The secure communication apparatus may be used in the target application server.

As shown in FIG. 12, the apparatus may include: a receiving module 1210, configured to receive a service request from a user equipment (UE) and an authentication result of the UE sent by an authentication and key management for applications (AKMA) authentication proxy, where the service request carries identification information of the target application server and an AKMA key identifier (A-KID) of the UE; a sending module 1220, configured to send a service response of the service request to the UE through the AKMA authentication proxy according to an authentication result of the UE.

In some embodiments, the sending module 1220 is specifically configured to, in response to the UE passing the authentication and authorization of the AKMA authentication proxy, return a service response to the UE through the AKMA authentication proxy.

In some embodiments, the receiving module 1210 is specifically configured to receive the service request of the UE, the authentication result of the UE, and the identity information of the UE sent by the AKMA authentication proxy.

This embodiment is equivalent to providing an effective solution to support authentication proxy in the AKMA scenario, and the same AKMA authentication proxy can correspond to a plurality of target application servers, so that the UE can communicate with a plurality of target application servers through one AKMA authentication proxy. On the premise of ensuring the communication security, the communication efficiency between the UE and the plurality of target application servers is improved, and more service requirements can be met.

Referring to FIG. 13, which is a schematic structural diagram of a communication apparatus 1300 provided in this embodiment, the communication apparatus 1300 may be a network device, or may be a user equipment, or may be a chip, a chip system, or a processor that supports the network device to implement the above methods, or may be a chip, a chip system, or a processor that supports the user equipment to implement the above methods, etc. The apparatus can be used to implement the methods described in the above method embodiments, and for details, the description in the above method embodiments may be referred to.

The communication apparatus 1300 may include one or more processors 1301. The processor 1301 may be a general-purpose processor or a special-purpose processor, or the like. For example, it may be a baseband processor or a central processing unit. The baseband processor may be used to process communication protocols and communication data. The central processor may be used to control the communication apparatuses (such as base stations, baseband chips, terminal devices, terminal device chips, DU or CU, etc.), execute computer programs, and process data of the computer programs.

Optionally, the communication apparatus 1300 may also include one or more memories 1302, on which a computer program 1304 may be stored. The processor 1301 executes the computer program 1304, so that the communication apparatus 1300 executes the method described in the above method embodiments. Optionally, the memory 1302 may also store data. The communication apparatus 1300 and the memory 1302 can be provided separately or integrated together.

Optionally, the communication apparatus 1300 may further include a transceiver 1305 and an antenna 1306. The transceiver 1305 may be called a transceiver unit, a transceiver machine, a transceiver circuit, etc., and is configured to implement transceiver functions. The transceiver 1305 may include a receiver and a transmitter. The receiver may be called a receiving machine or a receiving circuit, etc., used to implement the receiving function; and the transmitter may be called a transmitting machine, a transmitting circuit, etc., used to implement the transmitting function.

Optionally, the communication apparatus 1300 may also include one or more interface circuits 1307. The interface circuit 1207 is used to receive code instructions and transmit them to the processor 1301. The processor 1301 executes the code instructions to cause the communication apparatus 1300 to perform the methods described in the above method embodiments.

In one implementation, the processor 1301 may include a transceiver for implementing receiving and transmitting functions. For example, the transceiver may be a transceiver circuit, an interface, or an interface circuit. The transceiver circuit, interface or interface circuit used to implement the receiving and transmitting functions may be separate or integrated together. The above-mentioned transceiver circuit, interface or interface circuit may be used for reading and writing codes/data, or the above-mentioned transceiver circuit, interface or interface circuit may be used for signal transmission or transfer.

In one implementation, the processor 1301 may store a computer program 1303, and the computer program 1303 runs on the processor 1301, causing the communication apparatus 1300 to perform the methods described in the above method embodiments. The computer program 1303 may be solidified in the processor 1301, in which case the processor 1301 may be implemented by hardware.

In one implementation, the communication apparatus 1300 may include a circuit, which may implement the functions of sending or receiving or communicating in the foregoing method embodiments. The processor and transceiver described in the present application may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or user equipment, but the scope of the communication apparatus described in the present application is not limited thereto, and the structure of the communication apparatus may not be limited by FIG. 13. The communication apparatus may be a stand-alone device or may be part of a relatively large device. For example, the communication apparatus may be:
(1) an independent integrated circuit (IC), or chip, or chip system or subsystem;
(2) a collection of one or more ICs, optionally, the IC collection may also include a storage component for storing data and computer programs;
(3) an ASIC, such as a modem;
(4) a module that can be embedded in other device;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

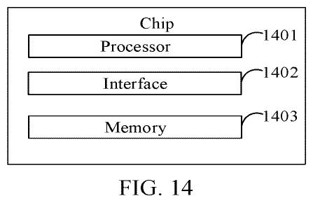

For the case where the communication device may be a chip or a chip system, the schematic structural diagram of the chip shown in FIG. 14 may be referred to. The chip shown in FIG. 14 includes a processor 1401 and an interface 1402. The number of processors 1401 may be one or more, and the number of interfaces 1402 may be multiple.

Optionally, the chip also includes a memory 1403, which is used to store necessary computer programs and data.

Those skilled in the art can also understand that the various illustrative logical blocks and steps listed in the embodiments of the present application can be implemented by an electronic hardware, a computer software, or a combination of both. Whether such functionality is implemented in hardware or software depends on the specific application and overall system design requirements. Those skilled in the art can use various methods to implement the described functions for each specific application, but such implementation should not be understood as exceeding the protection scope of the embodiments of the present application.

The present application also provides a readable storage medium on which instructions are stored. When the instructions are executed by a computer, the functions of any of the above method embodiments are implemented.

The present application also provides a computer program product, which, when executed by a computer, implements the functions of any of the above method embodiments.

In the above embodiments, it may be implemented in whole or in part by software, hardware, firmware, or any combination thereof. When implemented using software, it may be implemented in whole or in part in the form of a computer program product. The computer program product includes one or more computer programs. When the computer program is loaded and executed on a computer, processes or functions according to the embodiments of the present application are generated in whole or in part. The computer may be a general-purpose computer, a special-purpose computer, a computer network, or other programmable apparatuses. The computer program may be stored in the computer-readable storage medium, or transmitted from one computer-readable storage medium to another computer-readable storage medium, for example, the computer program may be transmitted from a website, computer, server or data center via a wire (e.g. coaxial cable, optical fiber, digital subscriber line (DSL)) or wireless (such as infrared, wireless, microwave, etc.) means to transmit to another website, computer, server or data center. The computer-readable storage medium may be any available medium that can be accessed by a computer or a data storage device such as a server, and data center, that contains one or more available media. The available medium may be a magnetic medium (e.g., a floppy disk, a hard disks, a tape), an optical medium (e.g., a high-density digital video disc (DVD)), or a semiconductor medium (e.g., a solid state disks (SSD)), etc.

Persons of ordinary skill in the art can understand that the first, second, and other numerical numbers involved in the present application are only for convenience of description and are not used to limit the scope of the embodiments of the present application, and also indicate the order.

At least one in the present application can also be described as one or more, and a plurality of can be two, three, four or more, which is not limited by the present application. In the embodiments of the present application, for a technical feature, the technical feature is distinguished by “first”, “second”, “third”, “A”, “B”, “C” and “D”, etc. The technical features described by “first”, “second”, “third”, “A”, “B”, “C” and “D” are in no particular sequential order or size order.

As used herein, the terms “machine-readable medium” and “computer-readable medium” refer to any computer program product, device, and/or apparatus (for example, a magnetic disk, an optical disk, a memory, a programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

The systems and techniques described herein may be implemented in a computing system that includes a back-end component (e.g., as a data server), or a computing system that includes a middleware component (e.g., an application server), or a computing system that includes a front-end component (e.g., a user computer having a graphical user interface or web browser through which the user can interact with implementations of the systems and techniques described herein), or a computing system that includes any combination of such back-end component, middleware component, or front-end component. The components of the system may be interconnected by any form or medium of digital data communication (e.g., a communications network). Examples of the communication network include: local area network (LAN), wide area network (WAN), and the Internet.

The computer system may include a client and a server. The client and the server are generally remote from each other and typically interact over a communication network. The relationship of the client and the server is created by the computer programs running on corresponding computers and having a client-server relationship with each other.

It should be understood that various forms of the process shown above may be used, with steps reordered, added or deleted. For example, each step described in the present application can be executed in parallel, sequentially, or in a different order. As long as the desired results of the technical solutions of the present application can be achieved, there is no limitation here.

In addition, it should be understood that the various embodiments described in the present application can be implemented alone or in combination with other embodiments if the scheme allows.

Those of ordinary skill in the art can appreciate that the units and algorithm steps of each example described in conjunction with the embodiments applied for herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of the present application.

Those skilled in the art can clearly understand that for the convenience and simplicity of description, the specific working processes of the systems, apparatuses and units described above can be referred to the corresponding processes in the foregoing method embodiments, and will not be described again here.

The above are only specific embodiments of the present application, but the protection scope of the present application is not limited thereto. Changes or substitutions that can easily thought of by any person familiar with the technical field within the technical scope disclosed in the present application should be covered by the protection scope of the present application. Therefore, the protection scope of the present application should be subject to the protection scope of the claims.

1. A secure communication method, applied to an authentication and key management for applications (AKMA) authentication proxy, wherein the method comprises:
receiving a service request of a target application server sent by a user equipment (UE), wherein the service request carries identification information of the target application server and an AKMA key identifier (A-KID) of the UE;
performing authentication and authorization on the UE according to the A-KID and the identification information of the target application server, and determining whether to authorize the UE to access the target application server; and
in response to authorizing the UE to access the target application server, forwarding the service request and an authentication result of the UE to the target application server.

2. The method according to claim 1, wherein before receiving the service request of the target application server sent by the user equipment (UE), the method further comprises:
receiving a session establishment request sent by the UE, wherein the session establishment request carries the A-KID of the UE;
establishing a transport layer security protocol TLS connection with the UE according to the A-KID of the UE;
wherein receiving the service request of the target application server sent by the UE comprises:
receiving the service request sent by the UE through the established TLS connection.

3. The method according to claim 1, wherein performing authentication and authorization on the UE according to the A-KID and the identification information of the target application server, and determining whether to authorize the UE to access the target application server, comprises:
determining whether a transport layer security protocol (TLS) connection has been established with the UE according to the A-KID;
in response to the TLS connection having been established with the UE, determining whether to authorize the UE to access the target application server according to a pre-configured policy of the AKMA authentication proxy and the identification information of the target application server.

4. The method according to claim 3, wherein performing authentication and authorization on the UE according to the A-KID and the identification information of the target application server, and determining whether to authorize the UE to access the target application server, further comprises:
in response to the TLS connection having not been established with the UE, establishing the TLS connection with the UE according to the A-KID, and requesting the UE to send a service request of the target application server after the TLS connection is established, wherein the service request carries the identification information of the target application server and the A-KID of the UE.

5. The method according to claim 2, wherein establishing the TLS connection with the UE according to the A-KID comprises:
sending an AKMA application key request to an AKMA anchor function (AAnF), wherein the key request carries the A-KID and an application function identification of the AKMA authentication proxy, and the application function identification of the AKMA authentication proxy comprises: a fully qualified domain name (FQDN), and a Ua* security protocol identifier;
receiving a first key K_{AF} returned by the AAnF according to the A-KID and the application function identification of the AKMA authentication proxy;
performing a mutual authentication with the UE and establishing the TLS connection with the UE based on the first key K_{AF} and a second key K_{AF} on the UE side.

6. The method according to claim 1, wherein the identification information of the target application server at least comprises: a FQDN, a Ua* security protocol identifier, an IP address, and a port number.

7. The method according to claim 1, wherein after sending the service request and the authentication result of the UE to the target application server, the method further comprises:
sending a service response of the target application server to the UE.

8. The method according to claim 1, wherein in response to authorizing the UE to access the target application server, forwarding the service request and the authentication result of the UE to the target application server, comprises:
determining whether the target application server has an authorization and needs to obtain identity information of the UE based on a pre-configured policy of the AKMA authentication proxy;
in response to the target application server having the authorization and needing to obtain the identity information of the UE, sending the identity information of the UE, the service request and the authentication result of the UE to the target application server;
in response to the target application server having no authorization or not needing to obtain the identity information of the UE, sending the service request and the authentication result of the UE to the target application server.

9. The method according to claim 8, wherein after sending the identity information of the UE, the service request and the authentication result of the UE to the target application server, the method further comprises:
sending corresponding authorization information and service response to the UE through service response information returned by the target application server.

10. The method according to claim 8, wherein in response to the target application server having the authorization and needing to obtain the identity information of the UE, sending the identity information of the UE, the service request and the authentication result of the UE to the target application server, comprises:
in response to the target application server not being within a 3GPP operator domain, sending a generic public subscription identifier (GPSI) of the UE to the target application server.

11. The method according to claim 1, wherein the AKMA authentication proxy and the target application server have a same application function identification, and the application function identification comprises: a FQDN and a Ua* security protocol identifier corresponding to an application function.

12. A secure communication method, applied to a user equipment (UE), wherein the method comprises:
sending a service request of a target application server to an authentication and key management for applications (AKMA) authentication proxy, wherein the service request carries identification information of the target application server and an AKMA key identifier (A-KID) of the UE; and
receiving response information returned by the AKMA authentication proxy.

13. The method according to claim 12, wherein before sending the service request of the target application server to the AKMA authentication proxy, the method further comprises:
obtaining an AKMA anchor key KARMA and the A-KID based on a key KAUSE of an authentication service function (AUSF) network element;
wherein K_{AKMA} is used to obtain a key K_{AF} in combination with the identification information of the target application server, and the key K_{AF} is used to establish a transport layer security protocol (TLS) connection with the AKMA authentication proxy.

14. The method according to claim 12, wherein sending the service request of the target application server to the AKMA authentication proxy comprises:
obtaining an address of the AKMA authentication proxy through the identification information of the target application server, wherein the identification information of the target application server at least comprises: a fully qualified domain name (FQDN), a Ua* security protocol identifier, an IP address, and a port number of the target application server;
sending the service request according to the address of the AKMA authentication proxy,
and/or,
wherein receiving the response information returned by the AKMA authentication proxy comprises:
receiving error code information sent by the AKMA authentication proxy or a service response returned by the target application server.

15. (canceled)

16. A secure communication method, applied to a target application server, wherein the method comprises:
receiving a service request of a user equipment (UE) and an authentication result of the UE sent by an authentication and key management for applications (AKMA) authentication proxy, wherein the service request carries identification information of the target application server and an AKMA key identifier (A-KID) of the UE; and
sending a service response of the service request to the UE through the AKMA authentication proxy according to the authentication result of the UE.

17. The method according to claim 16, wherein sending the service response of the service request to the UE through the AKMA authentication proxy according to the authentication result of the UE comprises:
in response to the UE passing an authentication and authorization of the AKMA authentication proxy, returning the service response to the UE through the AKMA authentication proxy.

18. The method according to claim 16, wherein receiving the service request of the UE and the authentication result of the UE sent by the AKMA authentication proxy comprises:
receiving the service request of the UE, the authentication result of the UE, and identity information of the UE sent by the AKMA authentication proxy.

19. A secure communication apparatus, applied to an authentication and key management for applications (AKMA) authentication proxy, wherein the apparatus comprises:
a transceiver; a memory; and a processor, respectively connected to the transceiver and the memory, and configured to, by executing computer-executable instructions on the memory, control the transceiver to receive and send a wireless signal, and implement the secure communication method according to claim 1.

20. A secure communication apparatus, applied to a user equipment (UE), wherein the apparatus comprises: a transceiver; a memory; and a processor, respectively connected to the transceiver and the memory, and configured to, by executing computer-executable instructions on the memory, control the transceiver to receive and send a wireless signal, and implement the secure communication method according to claim 12.

21. A secure communication apparatus, applied to a target application server, wherein the apparatus comprises: a transceiver; a memory; and a processor, respectively connected to the transceiver and the memory, and configured to, by executing computer-executable instructions on the memory, control the transceiver to receive and send a wireless signal, and implement the secure communication method according to claim 16.

22-24. (canceled)
